(19) United States
(12) Patent Application Publication
(10) Pub. No.: US 2003/0063948 A1
(43) Pub. Date: Apr. 3, 2003

(54) Clamping seat

(76) Inventor: Jung-Jung Liu, Taichung (TW)

Correspondence Address: Jung-Jung Liu, 58, MA YUAN WEST ST., TAICHUNG, TW

(21) Appl. No.: 09/968,048

(22) Filed: Sep. 28, 2001

(51) Int. Cl. F16D 1/00; F16B 1/00; B25G 3/00

(52) U.S. Cl. 403/344

(57) ABSTRACT

A clamping seat has a disk, a positioning mount disposed on the disk, and a movable mount disposed on the disk. The positioning mount has a first curved face, a pair of first clamping blocks, and a pair of second clamping blocks. The movable mount has a second curved face, a pair of third clamping blocks, and a pair of fourth clamping blocks. A first screw rod passes through the positioning mount and the movable mount to engage with a butterfly nut. A second screw rod passes through the positioning mount and the movable mount to engage with a hexagonal nut.

### BACKGROUND OF THE INVENTION

The present invention relates to a clamping seat. More particularly, the present invention relates to a clamping seat which clamps a seat support rod stably.

Referring to FIGS. 1 and 2, a conventional clamping seat has a disk 10′, a positioning mount 20′ disposed on the disk 10′, and a movable mount 30′ disposed on the disk 10′. The positioning mount 20′ has a first clamping face 21′. The movable mount 30′ has a second clamping face 31′. A first screw rod 28′ passes through the positioning mount 20′ and the movable mount 30′ to engage with a butterfly nut 38′. A second screw rod 28″ passes through the positioning mount 20′ and the movable mount 30′ to engage with a hexagonal nut 39′. A spring 29′ surrounds the first screw rod 28′. A seat plate 50′ is disposed on the disk 10′. A drummer seats on the seat plate 50′ (not shown in the figures). A seat support rod 40′ is clamped by the positioning mount 20′ and the movable mount 30′. However, the seat support rod 40′, the positioning mount 20′, and the movable mount 30′ are easily deformed.

### SUMMARY OF THE INVENTION

An object of the present invention is to provide a clamping seat which clamps a seat support rod stably.

Accordingly, a clamping seat comprises a disk, a positioning mount disposed on the disk, and a movable mount disposed on the disk. The positioning mount has a first curved face, a pair of first clamping blocks, and a pair of second clamping blocks. The movable mount has a second curved face, a pair of third clamping blocks, and a pair of fourth clamping blocks. A first screw rod passes through the positioning mount and the movable mount to engage with a butterfly nut. A second screw rod passes through the positioning mount and the movable mount to engage with a hexagonal nut.

### BRIEF DESCRIPTION OF THE DRAWINGS

FIG. 1 is a perspective view of a conventional clamping seat of the prior art;

FIG. 2 is a schematic view illustrating a seat plate disposed on a conventional clamping seat and a seat support rod clamped by the conventional clamping seat of the prior art;

FIG. 3 is a perspective view of a clamping seat of a preferred embodiment in accordance with the present invention;

FIG. 4 is a schematic view illustrating an operation of a clamping seat of a preferred embodiment in accordance with the present invention; and

FIG. 5 is a schematic view illustrating another operation of a clamping seat of a preferred embodiment in accordance with the present invention.

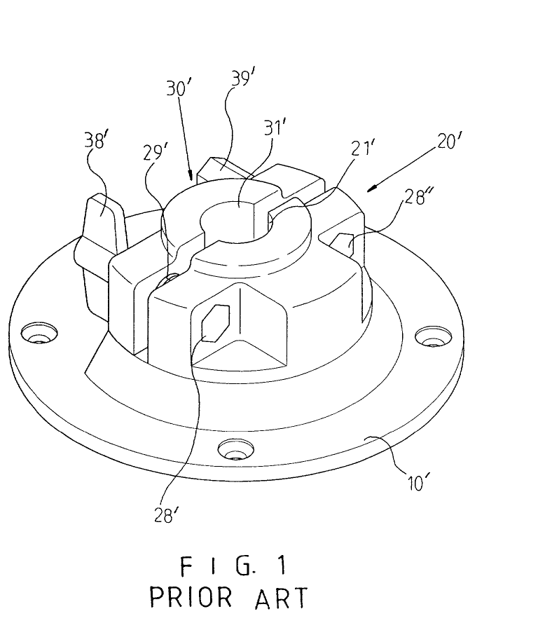

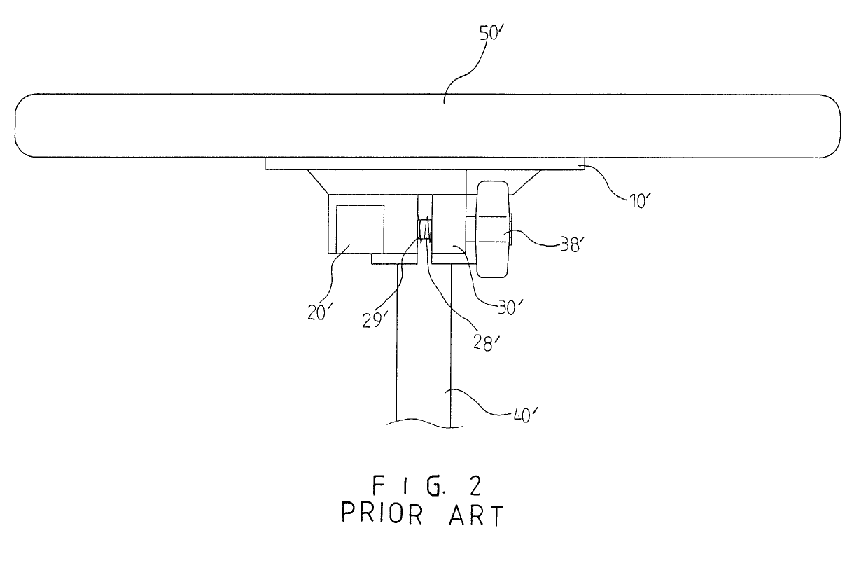

### DETAILED DESCRIPTION OF THE INVENTION

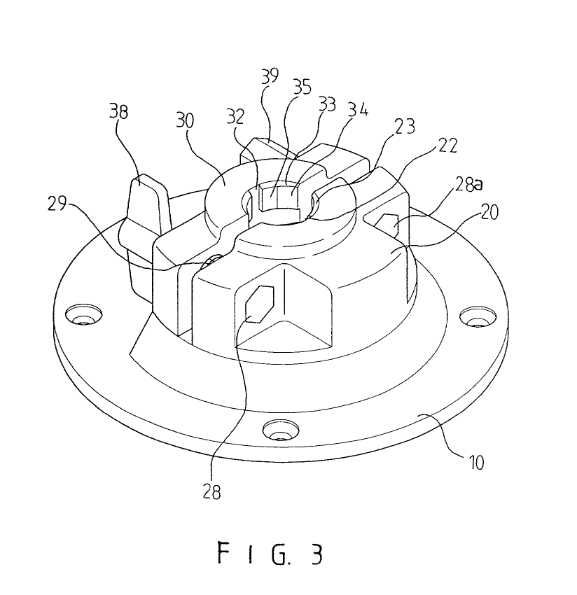

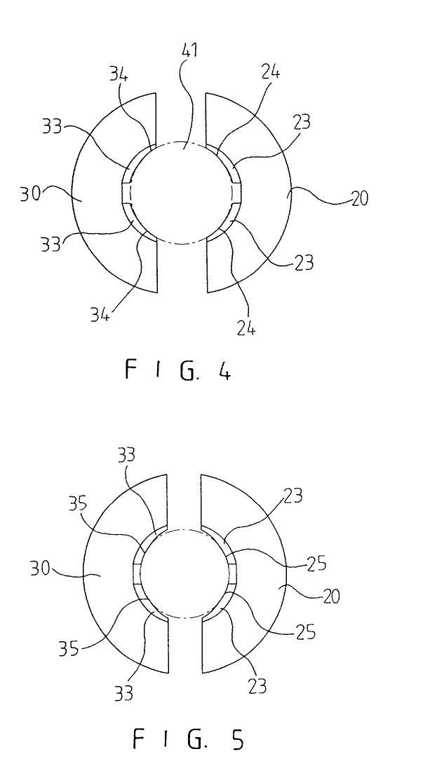

Referring to FIGS. 3 to 5, a clamping seat comprises a disk 10, a positioning mount 20 disposed on the disk 10, and a movable mount 30 disposed on the disk 10.

The positioning mount 20 has a first curved face 22, a pair of first clamping blocks 23, and a pair of second clamping blocks 25.

The movable mount 30 has a second curved face 32, a pair of third clamping blocks 33, and a pair of fourth clamping blocks 35.

A first screw rod 28 passes through the positioning mount 20 and the movable mount 30 to engage with a butterfly nut 38.

A second screw rod 28a passes through the positioning mount 20 and the movable mount 30 to engage with a hexagonal nut 39. A spring 29 surrounds the first screw rod 28.

A seat support rod 41 is clamped by the positioning mount 20 and the movable mount 30.

The invention is not limited to the above embodiment but various modification thereof may be made. Further, various changes in form and detail may be made without departing from the scope of the invention.

I claim:

1. A clamping seat comprises:
a disk,
a positioning mount disposed on the disk,
a movable mount disposed on the disk,
the positioning mount having a first curved face, a pair of first clamping blocks, and a pair of second clamping blocks,
the movable mount having a second curved face, a pair of third clamping blocks, and a pair of fourth clamping blocks,
a first screw rod passing through the positioning mount and the movable mount to engage with a butterfly nut, and
a second screw rod passing through the positioning mount and the movable mount to engage with a hexagonal nut.
